(19) United States
(12) Patent Application Publication
(10) Pub. No.: US 2024/0189833 A1
(43) Pub. Date: Jun. 13, 2024

(54) MODULAR CENTRIFUGAL SEPARATOR SYSTEM AND EXCHANGEABLE SEPARATION INSERT

(71) Applicant: Alfa Laval Corporate AB, LUND (SE)

(72) Inventors: Peter THORWID, SUNDBYBERG (SE); Anders EKSTRÖM, TÄBY (SE)

(73) Assignee: Alfa Laval Corporate AB, LUND (SE)

(21) Appl. No.: 18/286,423

(22) PCT Filed: Apr. 8, 2022
(86) PCT No.: PCT/EP2022/059450

§ 371 Date: Oct. 11, 2023

(30) Foreign Application Priority Data
May 3, 2021 (EP) 21171836.6

(51) Int. Cl. B04B 7/14; B04B 1/08; B04B 7/08; B04B 9/12; B04B 11/02

(52) U.S. Cl. CPC B04B 7/14; B04B 1/08; B04B 7/085; B04B 9/12; B04B 11/02

(57) ABSTRACT

A separator system includes a base unit and an exchangeable separation insert. The base unit includes a drive arrangement. The exchangeable separation insert includes a rotor casing configured to rotate about a rotational axis and a first stationary portion. The drive arrangement includes an entrainment member through which a portion of the exchangeable separation insert including the first stationary portion extends. The entrainment member engages with the rotor casing. The entrainment member has an axial extension <50%, such as <40% of a total axial extension of the rotor casing. The rotor casing is supported in the entrainment member over a distance <30%, such as <20%, such as <10% of the total axial extension of the rotor casing.

### TECHNICAL FIELD

The invention relates to a modular centrifugal separator system and an exchangeable separation insert for a modular centrifugal separator system.

### BACKGROUND

In the field of pharmaceuticals, biopharmaceuticals, biotechnology and thereto related fields, separation of substances from a liquid mixture such as, separation of cells from a cell culture mixture, are performed in a sterile environment. Traditionally, equipment made e.g. from stainless steel has been used, which equipment is sterilised between production batches.

Lately, disposable centrifugal separation equipment made for single use, i.e. for separation of one product batch or a limited number of product batches, has been introduced. Such centrifugal separation equipment comprises a base unit configured to be reused and for no contact with the product and single use portions, which are configured to be exchangeable and to come into contact with the product.

Two different design concepts have been applied, a first concept wherein a single use portion of the separation equipment comprising a rotor is supported to a large extend inside a rotatable member of the base unit, and a second concept wherein a single use portion is supported on a spindle. In separation equipment of the former kind, the rotatable member of the base unit supports at least some of the forces caused by the fluid pressure inside the rotor of the single use portion. In separation equipment of the latter kind, the single use portion is self-supporting in that it is configured to withstand the fluid pressure inside the rotor thereof.

Centrifugal separation equipment of the latter kind is disclosed e.g., in US 2011/0319248 A1 and WO 2014/000829 A1.

US 2011/0319248 A1 discloses a device that incorporates a single use centrifuge that is sterilized prior to use in the pharmaceutical, biopharmaceutical, biotechnology or related industries and is used for the removal of solids and/or other undesirable materials from one or more fluids and is connected to a bioreactor, fermentor, container or process by way of single use tubing, connectors and/or various fluid flow components.

WO 2014/000829 A1 discloses a separator for the centrifugal separation of a flowable product into various phases or for the centrifugal clarification of a product, comprising a rotatable drum with a drum lower section and a drum upper section, a means arranged in the drum for clarifying a product to be treated in the centrifugal field. One, more than one, or all of the following elements are made from plastic or a plastic composite: the drum lower section, the drum upper section, and the clarifying means.

### SUMMARY

It is an object to provide a centrifugal separation system configured for enabling flexibility in placement of fluid connections to a self-supporting single use separator rotor. To address this concern, a modular centrifugal separator system and an exchangeable separation insert having the features defined in the independent claims are provided.

According to an aspect, the object is achieved by a modular centrifugal separator system configured for separating a liquid feed mixture into a heavy phase and a light phase. The modular centrifugal separator system comprises a base unit and an exchangeable separation insert. The base unit comprises a stationary frame and a drive arrangement for rotating at least a portion of the exchangeable separation insert about a rotational axis extending in an axial direction. The exchangeable separation insert comprises a rotor casing configured to rotate about the rotational axis and forming a separation space and a first stationary portion arranged at a first axial end portion of the rotor casing and comprising at least one fluid connection for one of the liquid feed mixture, the heavy phase, and the light phase. The drive arrangement comprises an entrainment member through which a portion of the exchangeable separation insert comprising the first stationary portion extends. The entrainment member is journalled in the stationary frame and engages with the rotor casing. The entrainment member has an axial extension <40%, such as <30%, such as <20% of a total axial extension of the rotor casing. The rotor casing is supported in the entrainment member over a distance <10%, such as <5%, such as <3% of the total axial extension of the rotor casing.

Since a portion of the exchangeable separation insert extends through the entrainment member, which forms part of the drive arrangement, and since the first stationary portion extends through the entrainment member, through which a portion of the exchangeable separation insert comprising the first stationary portion extends, a spindle-less centrifugal separator is provided permitting at least one fluid connection to be arranged where a spindle would be provided in a centrifugal separator comprising a spindle. Thus, flexibility for placement of fluid connections is achieved. Moreover, the entrainment member has a short axial extension which supports the rotor casing of the exchangeable separation insert over an even shorter distance. Thus, the exchangeable separation insert inherently is self-supporting with respect to fluid pressure inside the exchangeable separation insert during use of the modular centrifugal separator system. Therefore, the total amount of rotating parts of the whole centrifugal separator may be lighter but stronger, thereby leading to a more practical construction. As a result, the above-mentioned object is achieved.

Moreover, it has been realised that only a short support distance, or in other words; a small contact area, is required between the rotor casing and the entrainment member since the contact between the rotor casing and the entrainment member will be arranged at diameter considerably larger than in a centrifugal separator system of the prior art wherein a self-supporting single use rotor is supported on a spindle.

Further, in comparison with a centrifugal separator system according to the above-discussed first concept of the prior art, wherein a single use rotor is supported inside a rotatable member of the base unit, the rotating mass of the present modular centrifugal separator system may be reduced.

The modular centrifugal separator system may be configured for use in the field of pharmaceuticals, biopharmaceuticals, biotechnology, and thereto related fields. In the modular centrifugal separator system, separation of substances from a liquid mixture such as separation of cells from a cell culture mixture, may be performed in a sterile environment.

In the modular centrifugal separator system, the liquid feed mixture is separated into a liquid heavy phase and a liquid light phase. For instance, the liquid feed mixture may be formed by a cell culture mixture such as a fermentation broth including a cell culture. The light phase may be formed by fermentation broth without the cells or with only a minimum rest amount of cells and/or cell debris. The heavy phase may comprise the cells and cell debris suspended in fermentation broth.

The base unit is configured for repeated use with different exchangeable separation inserts. That is, the base unit is reusable with new exchangeable parts such as the exchangeable separation insert after separation of one process batch or after separation of a limited number of process batches.

The exchangeable separation insert is configured for single use i.e., for separation of one batch only of liquid feed mixture or of a limited number of batches of liquid feed mixture.

Herein, the modular centrifugal separator system may also be referred to as system or separator system and the exchangeable separation insert may also be referred to as insert or separation insert.

The base unit comprises basic components for supporting the separation insert. The base unit is configured for rotating the rotor casing of the separation insert by supporting the separation insert in the entrainment member. The entrainment member may be supported in the stationary frame of the base unit. Such a stationary frame may be stationary in the sense that it is stationary during use of the separator system.

The entrainment member may be the only torque-transmitting member of the base unit configured for transmitting a torque between the drive arrangement and the rotatable portion of the exchangeable separation insert, i.e. the rotor casing.

Accordingly, the only purpose of the entrainment member may be that of torque transmission to the rotor casing and positioning the rotor casing along the axial direction in the base unit. Thus, the entrainment member does not support the rotor casing to withstand fluid pressure inside the rotor casing. The rotor casing as such is devised to withstand the fluid pressure inside the rotor casing during use of the modular centrifugal separator system. Put differently, the rotor casing may be self-supporting.

The rotor casing of the separation insert is configured to rotate during use of the modular centrifugal separator system. Inside the separation space, there may be arranged a separation aid such as e.g., a stack of frustoconical separation discs.

The first stationary portion is configured to be stationary during use of the modular centrifugal separator system. The at least one fluid connection may be configured for conducting the liquid feed mixture to the rotor casing and/or the heavy phase from the rotor casing and/or the light phase from the rotor casing. The at least one fluid connection may comprise one or more tubes extending to and/or from the exchangeable separation insert. The at least one fluid connection may comprise part of one or more interfaces between the rotor casing and the stationary portion.

During use of the modular centrifugal separator system the liquid feed mixture is separated into the light and heavy phases in the exchangeable separation insert. More specifically, as the rotor casing is rotated about its rotational axis, the gravitational field generated by the rotation will cause the liquid feed mixture in the separation space to separate into the light and heavy phases. That is, the rotor casing is that part of the modular centrifugal separator system wherein separation takes place during use thereof.

During use of the modular centrifugal separator system, one or more liquids is/are conducted to and/or from the separation space in the rotor casing via the first stationary portion. The liquids are one or more of the liquid feed mixture, the separated heavy phase, and the separated light phase. According to some embodiments, the exchangeable separation insert may comprise a second stationary portion. In such embodiments, one or more of the liquids is/are conducted to and/or from the separation space via the second stationary portion.

The exchangeable separation insert may be configured to form the only part of the modular centrifugal separator system, which is in contact with one or more of the liquid feed mixture and the heavy and light phases during use of the separator system.

The exchangeable separation insert may be provided to a user as a sterile entity. That is, at least the inside of the separation insert which comes into contact with the liquids is sterile, including insides of the first stationary portion and an optional second stationary portion and to the stationary portion/s connected tubes. Thus, when the exchangeable separation insert is installed in the base unit, the user will readily have available a centrifugal separator system with a sterile environment for separation of the liquid feed mixture. The exchangeable separation insert may be mounted in the base unit by the user.

Herein, the terms mount and mounting of a part generally relates to installation of the relevant part in the base unit.

According to embodiments, the rotor casing may comprise a plastic material portion and a fibre reinforced portion extending circumferentially around the plastic material portion. The fibre reinforced portion may be configured for rendering the rotor casing self-supporting during use of the modular centrifugal separator system. In this manner, the rotor casing may be configured for withstanding the fluid pressure within the separation space during use of the separation system. Accordingly, a self-supporting rotor casing and exchangeable separation insert may be provided.

Further, in comparison with a rotor casing comprising a plastic material portion and no fibre reinforce portion or other particular fluid pressure reinforcing structure for the plastic material portion, a wall thickness of the rotor casing may be considerably reduced. Accordingly, also the outer dimensions and the weight of the rotor casing may be reduced.

According to embodiments, the rotor casing may comprise a ring member extending along a periphery of the rotor casing. The ring member may support an axially extending portion of the rotor casing and a radially extending portion of the rotor casing. In this manner, the rotor casing may be configured for withstanding an axially extending component of the load caused by the fluid pressure within the separation space during use of the separation system. Accordingly, a self-supporting rotor casing and exchangeable separation insert may be provided.

According to embodiments, the exchangeable separation insert may comprise a second stationary portion arranged at a second axial end portion of the rotor casing. The second stationary portion may comprise at least one fluid connection for one of the liquid feed mixture, the heavy phase, and the light phase. In this manner, fluid connections may be provided at both axial ends of the rotor casing of a self-supporting separation insert. Conditions for providing flexibility with respect to the fluid connections of the separator system thus, may be provided.

According to embodiments, the exchangeable separation insert may comprise a bearing forming a journal between the rotor casing and the second stationary portion of the exchangeable separation insert. In this manner, the rotor casing may be rotatably supported at its second axial end portion to ensure stable rotation of the rotor casing in the base unit during use of the separator system. Such rotatable support accordingly, may be provided in the separation insert.

According to a further aspect, there is provided an exchangeable separation insert for a modular centrifugal separator system according to aspects and/or embodiments discussed herein. The exchangeable separation insert comprises a rotor casing configured to rotate about a rotational axis extending in an axial direction and forming a separation space, a first stationary portion arranged at a first axial end portion of the rotor casing, and a second stationary portion arranged at a second axial end portion of the rotor casing, the first and second stationary portions comprising fluid connections for a liquid feed mixture, a separated heavy phase, and a separated light phase.

In this manner there is provided an exchangeable separation insert for embodiments of a modular centrifugal separator system as discussed herein, which offers the above discussed advantage of placement of fluid connections.

Further features of, and advantages with, the invention will become apparent when studying the appended claims and the following detailed description.

### BRIEF DESCRIPTION OF THE DRAWINGS

Various aspects and/or embodiments of the invention, including its particular features and advantages, will be readily understood from the example embodiments discussed in the following detailed description and the accompanying drawings, in which:

FIGS. 1a and 1b schematically illustrate embodiments a modular centrifugal separator system,

FIG. 2 schematically illustrates a cross section through a base unit of a modular centrifugal separator system,

FIG. 3 schematically illustrates a cross-section through an exchangeable separation insert according to embodiments,

FIG. 4 schematically illustrates a cross section through a portion of a modular centrifugal separator system,

FIGS. 5a and 5b schematically illustrate a modular centrifugal separator system according to embodiments, and

FIGS. 6a and 6b schematically illustrate embodiments of entrainment members.

### DETAILED DESCRIPTION

Aspects and/or embodiments of the invention will now be described more fully. Like numbers refer to like elements throughout. Well-known functions or constructions will not necessarily be described in detail for brevity and/or clarity.

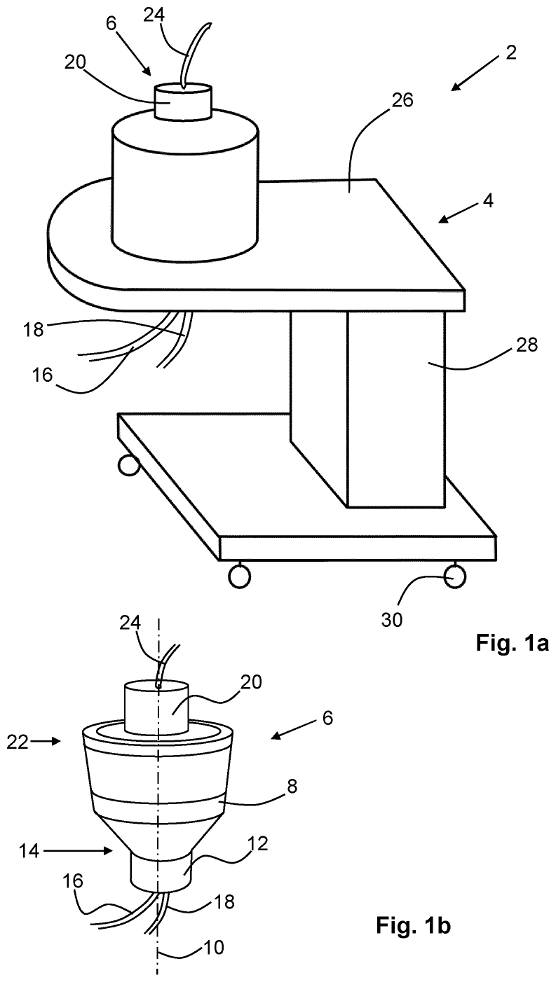

FIGS. 1a and 1b schematically illustrate embodiments a modular centrifugal separator system 2. The modular centrifugal separator system 2 is configured for separating a liquid feed mixture into a heavy phase and a light phase. The modular centrifugal separator system 2 may be configured for use in the field of pharmaceuticals, biopharmaceuticals, and/or biotechnology. For instance, the modular centrifugal separator system 2 may form part of a set-up in a plant for the production of cells such as, CHO cells (Chinese Hamster Ovary cells), or production of other matter resulting from processes in the biotech/pharma industry.

The modular centrifugal separator system 2 comprises a base unit 4 and an exchangeable separation insert 6. In FIG. 1a, the modular centrifugal separator system 2 is shown in an assembled state i.e., with the separation insert 6 mounted in the base unit 4. In FIG. 1b, the exchangeable separation insert 6 is shown.

The modular centrifugal separator system 2 is modular in the sense that it comprises the base unit 4 and the exchangeable separation insert 6. The exchangeable separation insert 6 is exchanged for each new batch of liquid feed mixture, which is to be separated. Alternatively, the exchangeable separation insert 6 may be exchanged for each new type of liquid feed mixture, which is to be separated, i.e. one or more subsequent batches containing the same liquid feed mixture may be separated utilising the same separation insert 6.

During use of the modular centrifugal separator system 2, the liquid feed mixture, the heavy phase, and the light phase only come into contact with the inside of the separation insert 6. The base unit 4 does not come into contact with the liquid feed mixture or any of the heavy and light phases.

The separation insert 6 comprises a rotor casing 8 forming a separation space. The rotor casing 8 is configured to rotate about a rotational axis 10 extending in an axial direction. The separation insert 6 further comprises a first stationary portion 12 arranged at a first axial end portion 14 of the rotor casing 8. The first stationary portion 12 comprises at least one fluid connection 16, 18 for one of the liquid feed mixture, the heavy phase, and the light phase. Each of the fluid connections 16, 18 comprises a tube.

In the illustrated embodiments, the separation insert 6 comprises a second stationary portion 20 arranged at a second axial end portion 22 of the rotor casing 8. The second stationary portion 20 may comprise at least one fluid connection 24 for one of the liquid feed mixture, the heavy phase, and the light phase. Each of such fluid connections 24 comprises a tube.

The fluid connections 16, 18, 24 of the separation insert 6 in particular, the tubes of the fluid connections 16, 18, 24, may be configured for connecting the separator system 2 to other equipment external of the separator system 2 in a production facility of a user. Thus, the liquid feed mixture may be conducted from external equipment to the separator system 2 and the separated light and heavy phases may be conducted from the separator system 2 to external equipment.

In the illustrated embodiments, the first stationary portion 12 comprises two of the three fluid connections and the second stationary portion 20 comprises one of the three fluid connections. For instance, the first stationary portion 12 may comprise a first fluid connection 16 for the liquid feed mixture and a second fluid connection 18 for the separated light phase. The second stationary portion 20 may comprise a third fluid connection 24 for the separated heavy phase.

According to alternative embodiments, the distribution of the fluid connections 16, 18, 24 may be different between the first and second stationary portions 12, 20. Accordingly, which of the liquid feed mixture, the heavy phase, and the light phase flows through which of the first and second stationary portions 12, 20 may differ.

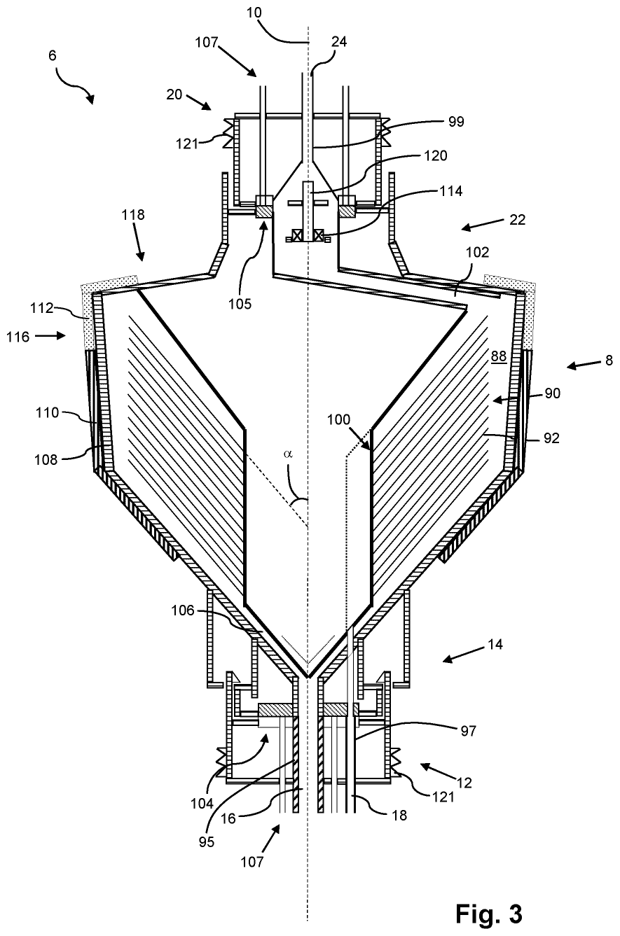

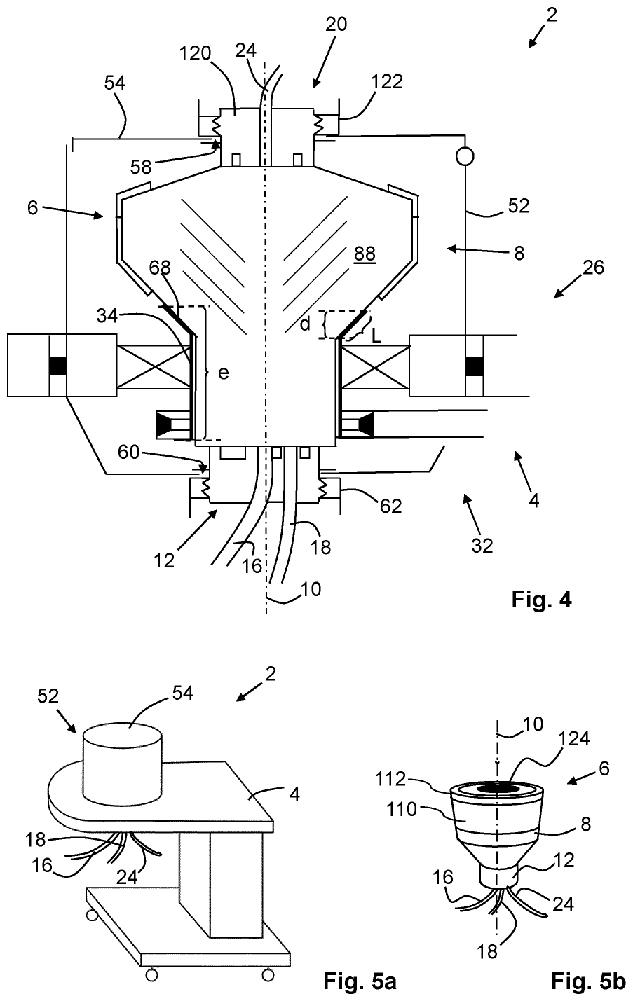

An exchangeable separation insert 6 is discussed in further detail below with reference to FIGS. 3 and 4.

The base unit 4 comprises components for supporting and rotating the exchangeable separation insert 6. Thus, the base unit 4 comprises inter alia a stationary frame 26 and a drive arrangement for rotating at least a portion of the exchangeable separation insert 6 about the rotational axis 10. The stationary frame 26 may comprise a vertical member 28. Part of the drive arrangement may be arranged in the vertical member 28.

The stationary frame 26 is stationary during use of the modular centrifugal separator system 2. However, the base unit 4 as such may be movable, e.g. in order to be positioned at different locations at a production facility of a user. For this purpose, the stationary frame 26 may be provided with wheels 30.

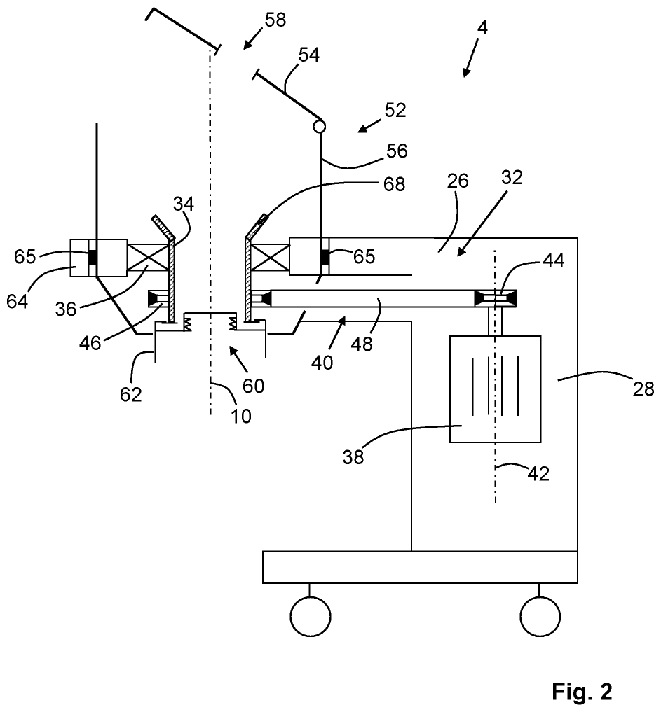

The base unit 4 is further discussed below inter alia with reference to FIG. 2.

FIG. 2 schematically illustrates a cross section through a base unit 4 of a modular centrifugal separator system. That is, in FIG. 2 an exchangeable separation insert of the separator system has been omitted. The separator system may be a separator system 2 as discussed above with reference to FIGS. 1a and 1b.

As mentioned above, the base unit 4 comprises the stationary frame 26 and a drive arrangement 32. The drive arrangement 32 comprises an entrainment member 34. The entrainment member 34 is configured for a portion of the exchangeable separation insert to extend therethrough and for supporting the exchangeable separation insert in the base unit 4, see further below with reference to FIG. 4. The entrainment member 34 is arranged to rotate about the rotational axis 10. The entrainment member 34 is journalled in the stationary frame 26. The entrainment member 34 may be journaled in one or more ball, roller, and/or plain bearings 36 in the stationary frame 26.

The drive arrangement 32 comprises an electric motor 38, and a transmission 40 arranged between the electric motor 38 and the entrainment member 34. The transmission 40 provides for the electric motor 38 to be arranged axially beside the entrainment member 34. An axis 42 of rotation of the electric motor 38 may extend substantially in parallel with the rotational axis 10 of the entrainment member 34.

In the illustrated embodiments, the transmission 40 comprises a belt drive comprising a first pulley 44 arranged on the electric motor 38, a second pulley 46 arranged on the entrainment member 34, and a belt 48 extending between the first and second pullies 44, 46. Alternatively, the transmission may be a gear transmission comprising cog wheels, or any other suitable transmission for transferring torque from the electric motor 38 to the entrainment member 34.

In these embodiments, the stationary frame 26 comprises a vertical member 28. The electric motor 38 is arranged at least partially inside the vertical member 28. In this manner, the electric motor 38 is protectively arranged within the stationary frame 26. A user of the modular centrifugal separator will not risk coming into contact with rotating parts of, or at, the electric motor 38. Similarly, the belt 48 may be arranged at least partly inside the stationary frame 26 in order to prevent a user of the modular centrifugal separator from coming into contact therewith.

The stationary frame 26 comprise an enclosing member 54. More specifically, according to some embodiments, such as the illustrated embodiments, the stationary frame 26 may comprise a housing 52. The entrainment member 34 is arranged inside the housing 52. The housing 52 comprises an enclosing member 54 in the form of a lid 54, which is pivotably or removably connected to a first housing portion 56 of the housing 52.

A first opening 60 is provided opposite to the lid 54. The first opening 60 may be provided in the housing 52, and/or in the stationary frame 26. The first opening 60 forms a through hole thus, permitting at last a portion of a first stationary portion of the separation insert to extend therethrough. An engagement member 62 is arranged to engage with a first stationary portion of a separation insert at the first opening 60. See further below with reference to FIG. 4.

The lid 54 is provided with a second opening 58. The second opening 58 forms a through hole in the lid 54.

In an open position of the lid 54, access is provided to the entrainment member 34 inside the housing 52 e.g., for mounting or exchanging a separation insert in the entrainment member 34. Thus, in order to mount an exchangeable separation insert in the entrainment member 34, and/or remove it therefrom, the lid 54 is moved to its open position or simply removed. Once the exchangeable separation insert has been positioned in the entrainment member 34, the lid 54 is moved back to a closed position.

In the closed position of the lid 54, the second opening 58 is configured for at least part of a second stationary portion of the separation insert to extend therethrough. During use of the separator system the lid 54 is arranged in its closed position. Thus, the entrainment member 34 cannot be accessed by a user of the modular centrifugal separator during use of the separator system.

The stationary frame 26 comprises a protruding member 64. The housing 52 is connected to the protruding member 64. The housing 52 is connected to the protruding member 64 such that access is provided at both ends of the housing 52 along the rotational axis 10. Suitably, the housing 52 is connected to the protruding member 64 in a manner such that access is provided to that end of the housing 52 where the lid 54 is arranged. Thus, a user may access an inside of the housing 52, e.g. for exchanging the separation insert in the entrainment member 34. Moreover, since access is provided at opposite ends of the housing 52 along the rotational axis 10, the user will be able to easily access fluid connections of the separation insert at both ends of the separation insert at the housing 52.

The entrainment member 34 is journalled inside the housing 52 of the stationary frame 26. That is, the bearing 36 in which the entrainment member 34 is journalled is arranged within the housing 52.

According to some embodiments, the housing 52 may be suspended in the protruding member 64 via at least one resilient connector 65. In this manner, the housing 52 may form a dynamic system together with the entrainment member 34 and a rotor casing of a separation insert arranged inside the housing 52, in the entrainment member 34. Thus, the journaling of the entrainment member 34 in the housing 52 as well as connections between the housing 52 and the remainder of the stationary frame 26 are affected to a lesser degree than if the housing would be fixedly attached to the protruding member 64, when the entrainment member 34 together with a rotor casing of a separation insert passes the critical speed during operation of the separator system.

The resilient connector 65 may for instance be made from natural or synthetic rubber.

The entrainment member 34 comprises a frustoconical wall member 68 arranged on a first axial side of the bearing 36. The frustoconical wall member 68 has an imaginary apex on an opposite second axial side of the bearing 36, at the bearing 36, or one the first axial side of the bearing 36 closer to the bearing 36 than the wall member 68 itself. When positioned in the entrainment member 34, an exchangeable separation insert having a conical or frustoconical shape is supported by the frustoconical wall member 68.

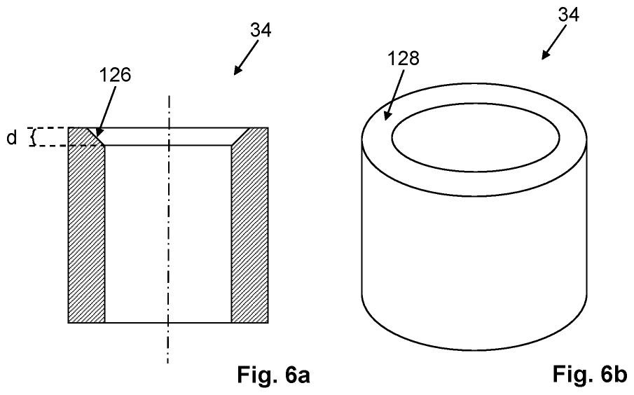

Alternative embodiments of the entrainment member 34 are discussed below with reference to FIGS. 6a and 6b.

According to some embodiments, the at least one bearing 36 may have an inner diameter of at least 80 mm. In this manner, the at least one bearing 36 is sized such that a portion of the entrainment member 34 may fit within the at least one bearing 36. Also, in this manner, the at least one bearing 36 is sized such that a portion of a separation insert fits within the entrainment member 34 and the at least one bearing 36. According to some embodiments, the at least one bearing 36 may have an inner diameter within a range of 80-150 mm. According to one none limiting example the at least one bearing 36 may have an inner diameter of approximately 120 mm.

FIG. 3 schematically illustrates a cross-section through an exchangeable separation insert 6 according to embodiments. The exchangeable separation insert 6 may form part of a modular centrifugal separator system, such as the modular centrifugal separator system 2 discussed above in connection with FIGS. 1a and 1b. Accordingly, the exchangeable separation insert 6 may be configured for a portion thereof extending through an entrainment member 34 of a base unit 4 as discussed above in connection with FIG. 2.

The exchangeable separation insert 6 comprises a rotor casing 8, a first stationary portion 12, and a second stationary portion 20. The exchangeable separation insert 6 is configured to rotate about a rotational axis 10. The rotor casing 8 is arranged between the first stationary portion 12 and the second stationary portion 20. The first stationary portion 12 is arranged at a first axial end portion 14 of the rotor casing 8. The second stationary portion 20 is arranged at a second axial end portion 22 of the rotor casing 8. During operation of the modular centrifugal separator, the first stationary portion 12 is arranged at a lower axial end of the exchangeable separation insert 6, whereas the second stationary portion 20 is arranged at an upper axial end of the exchangeable separation insert 6.

The rotor casing 8 forms and delimits a separation space 88 therein. The exchangeable separation insert 6 comprises a stack 90 of frustoconical separation discs 92 arranged in the separation space 88. The separation discs 92 in the stack 90 are arranged with an imaginary apex at the first stationary portion 12 and/or pointing towards the first stationary portion 12. The stack 90 may comprise at least 50 separation discs 92, such as at least 100 separation discs 92, such as at least 150 separation discs 92. Mentioned as an example, a separation disc 92 may have an outer diameter within a range of 160-400 mm, an inner diameter within a range of 60-100 mm, and an angle α between the rotational axis 10 and an inner surface of each of the discs 92 within a range of 35-45 degrees. For clarity reasons, only a few discs 92 are shown in FIG. 3.

The stack 90 of separation discs 92 forms a separation aid configured to facilitate separation of the light and heavy phases.

The first stationary portion 12 comprises at least one fluid connection 16, 18 for one of the liquid feed mixture, the heavy phase, and the light phase 94. The second stationary portion 20 comprises at least one fluid connection 24 for one of the liquid feed mixture, the heavy phase, and the light phase.

A first conduit portion 95 forms part of a first fluid connection 16 at the first stationary portion 12. The first conduit portion 95 of the first fluid connection 16 extents through the first stationary portion 12. A second conduit portion 97 forms part of a second fluid connection 18 at the first stationary portion 12. The second conduit portion 97 of the second fluid connection 18 extents through the first stationary portion 12. In these embodiments, the exchangeable separation insert 6 comprises a third fluid connection 24 arranged at the second stationary portion 20. A third conduit portion 99 forms part of the third fluid connection 24. The third conduit portion 99 of the third fluid connection 24 extents through the second stationary portion 20.

The first, second, and third conduit portions 95, 97, 99 may comprise tubing, such as plastic tubing.

In these embodiments, during use of the separator system, the first fluid connection 16 is configured for conducting the liquid feed mixture to the rotor casing 8, the second fluid connection 18 is configured for conducting the separated light phase the rotor casing 8, and the third fluid connection 24 is configured for conducting in the separated heavy phase from the rotor casing 8. From the first fluid connection 16, the liquid feed mixture flows into the separation space 88 on the rotational axis 10. The liquid feed mixture is distributed from the rotational axis 10 into the separation space 88 and the disc stack 90. The separated light phase flows in the disc stack 90 towards the rotational axis 10 and leaves the separation space 88 at a radial position between the rotational axis 10 and the radially inner edges 100 of the separation discs 92.

Inside the rotor casing 8 there is/are arranged one or more outlet conduits 102 for the separated heavy phase from the separation space 88. The one or more outlet conduits 102 extend from a radially outer portion of the separation space 88 towards the rotational axis 10. The one or more outlet conduits 102 may each comprise a pipe or a tube. Depending on the number of outlet conduits 102 and e.g., the density and/or viscosity of the heavy phase, each pipe or tube may have an inner diameter within a range of 2-10 mm. In this example, there is provided a single outlet conduit 102. However, there may be at least two such outlet conduits, such as at least three or such as at least five outlet conduits, evenly distributed over the circumference of the rotor casing 8. The outlet conduit 102 has a conduit inlet arranged at the radially outer portion and a conduit outlet at a radially inner portion. The outlet conduit 102 is arranged at an axially upper portion of the separation space 88.

The first stationary portion 12 abuts against the rotor casing 8. The second stationary portion 20 abuts against the rotor casing 8. Sealing arrangements 104, 105 are provided between the respective first and second stationary portions 12, 20 and the rotor casing 8. The sealing arrangements 104, 105 may form part of the stationary portions 12, 20 and/or of the rotor casing 8. In these embodiments, each of the sealing arrangements 104, 105 comprises rotating sealing surfaces forming part of the rotor casing 8 and stationary sealing surfaces forming part of the stationary portions 12, 20.

The sealing arrangements 104, 105 form mechanical seals between the stationary portions 12, 20 and the rotor casing 8. Thus, the exchangeable separation insert 6 is provided with mechanically hermetically sealed inlet and outlets. More specifically, the sealing arrangements 104, 105 provide mechanical hermetical sealings for each of the first, second, and third fluid connections 16, 18, 24 between the rotor casing 8 and the respective first and second stationary portions 12, 20.

A coolant may be provided to the sealing arrangements 104, 105 in a known manner e.g., via the indicated tubing 107.

The first, second, and third fluid connections 16, 18, 24 may comprise tubing, such as plastic tubing.

During operation, the rotor casing 8, arranged in an entrainment member of a base unit, is brought into rotation around the rotational axis 10. Liquid feed mixture to be separated is supplied via the first fluid connection 16 arranged in the first stationary portion 12 and one or more guiding channels 106 into the separation space 88. Due to a density difference within the liquid feed mixture, it is separated into a liquid light phase and a liquid heavy phase. This separation is facilitated by the separation discs 92 of the stack 90 fitted in the separation space 88. The heavy phase may comprise particles, such as e.g. cells. The heavy phase may comprise a concentrated mixture of particles and the same liquid as the light phase.

The separated liquid heavy phase is conducted from the periphery of the separation space 88 via outlet conduit 102 and out of the rotor casing 8 to the third fluid connection 24 arranged in the second stationary portion 20. Separated liquid light phase is forced radially inwardly through the disc stack 90 and led out of the rotor casing 8 to the second fluid connection 18 arranged in the first stationary portion 12. Consequently, in this embodiment, the liquid feed mixture is supplied at a lower axial end of the exchangeable separation insert 6, the separated light phase is discharged at the lower axial end, and the separated heavy phase is discharged at the upper axial end of the exchangeable separation insert 6.

According to alternative embodiments, the distribution of the fluid connections 16, 18, 24 may be different between the first and second stationary portions 12, 20. Accordingly, which of the liquid feed mixture, the heavy phase, and the light phase flows through which of the first and second stationary portions 12, 20 may differ between embodiments.

The rotor casing 8 comprises a plastic material portion 108 and a fibre reinforced portion 110 extending circumferentially around the plastic material portion 108. Thus, the rotor casing 8 may be configured to be self-supporting with a comparatively low wall thickness of the rotor casing 8. Accordingly, there may not be required any separate rotor structure outside the rotor casing which is devised for supporting the load of the fluid pressure inside the rotor casing 8 during use of the separator system. In FIG. 3, the plastic material portion 108 of the rotor casing 8 is indicated with horizontal hatching.

The plastic material portion 108 may comprise e.g., polyamide, polyester, or polyethylene. The plastic material portion 108 may form the separation space 88 of the rotor casing 8. The plastic material portion 108 may be manufactured by injection moulding.

The plastic material portion 108 may be fibre reinforced and accordingly, may comprise fibres such as, carbon fibres, aramid fibres, glass fibres, or similar high strength fibres. Such fibres may be short and arranged non-unidirectionally in the plastic material portion 108. The fibres being short may mean that the fibres have a length shorter or substantially shorter than the length of the circumference of the rotor casing 8.

The fibre reinforced portion 110 may comprise one or more of carbon fibres, aramid fibres, glass fibres, or similar high strength fibres. A main portion of the fibres of the fibre reinforced portion 110 may extend in a circumferential direction of the rotor casing 8. At least 50% of the fibres may be arranged unidirectional in the fibre reinforced portion 110. The length of the fibres may be longer than the circumference of the rotor casing 8. The fibres may be embedded e.g., in epoxy or polyester resin. In FIG. 3, the fibre reinforced portion 110 of the rotor casing 8 is indicated with vertical hatching.

The fibre reinforced portion 110 may extend over a partial axial length of the plastic material portion 108. For instance, the fibre reinforced portion 110 may extend over an axial length of the rotor casing 8 within a range of 50-90% of the total axial length of the rotor casing 8.

The fibre reinforced portion 110 may be moulded directly onto the plastic material portion 108.

The rotor casing 8 comprises a ring member 112 extending along a periphery of the rotor casing 8. The ring member 112 supports an axially extending portion 116 of the rotor casing 8 and a radially extending portion 118 of the rotor casing 112. Accordingly, the ring member 112 extends over a transitional portion between a mainly axially extending portion 116 and a mainly radially extending portion 118 of the rotor casing 8. In FIG. 3, the ring member 112 of the rotor casing 8 is indicated with dotted hatching.

Thus, the self-supporting property of the rotor casing 8 is further improved. One purpose of the ring member 112 may be to support axially extending load caused by the fluid pressure within the separation space 88 during use of the separation system.

According to some embodiments, for manufacturing reasons, the plastic material portion 108, may comprise two parts such that during manufacturing, access to the separation space 88 is provided for placing the separation aid in the separation space 88. The radially extending portion 118 of the rotor casing 8 may be one of these two parts and it may close the separation space 88. Since the ring member 112 supports the axially extending portion 116 of the rotor casing 8 and the radially extending portion 118 of the rotor casing 8, the radially extending portion 118 is prevented from coming loose from the rotor casing 8.

The ring member 112 may be formed from a metallic material such as, steel. Alternatively, the ring member 112 may be formed from a material similar to the fibre reinforced portion 110 and similarly comprising unidirectional fibres. The ring member 112 may abut against the plastic material portion 108 of the rotor casing 8. Additionally, the ring member 112 may abut against the fibre reinforced portion 110. Irrespectively, of the material from which the ring member 112 is manufactured, the ring member 112 forms a separate part that is mounted on the plastic material portion 108 and/or the fibre reinforced portion 110

The ring member 112 may engage with the axially extending portion 116 of the rotor casing 8 e.g., via threads or a bayonet coupling. The axially extending portion 116 with which the ring member 112 engages, may be provided by the plastic material portion 108 and/or the fibre reinforced portion 110.

The exchangeable separation insert 6 comprises a bearing 114 forming a journal between the rotor casing 8 and the second stationary portion 20. The bearing 114 supports the rotor casing 8 at its second axial end portion 22. In the illustrated embodiments, the bearing 114 is arranged in the rotor casing 8. A shaft 120 is securely fixed in the second stationary portion 20 and extends into the rotor casing 8 and the bearing 114.

During use of the separator system, the second stationary portion 20 is fixedly positioned in the base unit of the separator system. Thus, the shaft 120 is fixedly arranged in the separator system and the bearing 114 is securely positioned in the separator system.

According to alternative embodiments, the bearing 114 may be arranged in the second stationary portion 20 and the shaft may be fixed in the rotor casing 8.

For the purpose of fixing the first and second stationary portions 12, 20 in the base unit of the separator system, each of the first and second stationary portions 12, 20 may be provided with suitable measures therefore. In the illustrated embodiments, threads 121 are provided on each of the first and second stationary portions 12, 20. Alternatively or additionally, there may be provided a bayonet coupling, a flange provided with through holes for screws to extend therethrough, a flange provided for clamping to the base unit, etc.

As mentioned above, according to an aspect of the present disclosure, there is provided an exchangeable separation insert 6 for a modular centrifugal separator system according to aspects and/or embodiments discussed herein. The exchangeable separation insert 6 comprises a rotor casing 8 configured to rotate about a rotational axis 10 extending in an axial direction and forming a separation space 88, a first stationary portion 20 arranged at a first axial end portion 14 of the rotor casing 8, and a second stationary portion 20 arranged at a second axial end portion 22 of the rotor casing 8, the first and second stationary portions 14, 20 comprising fluid connections 16, 18, 24 for a liquid feed mixture, a separated heavy phase, and a separated light phase.

Accordingly, FIG. 3 schematically illustrates embodiments of such a separation insert 6. Also, the above discussion referring to FIG. 3 relates to such a separation insert 6.

According to embodiments, as discussed above, the rotor casing 8 may comprise a plastic material portion 108 and a fibre reinforced portion 110 extending circumferentially around the plastic material portion 108.

According to embodiments, as discussed above, the rotor casing 8 may comprise a ring member 112 extending along a periphery of the rotor casing 8. The ring member 110 supports an axially extending portion 116 of the rotor casing 8 and a radially extending portion 118 of the rotor casing 8.

The exchangeable separation insert 6 comprises a first sealing arrangement 104 between the rotor casing 8 and the first stationary portion 12 and a second sealing arrangement 105 between the rotor casing 8 and the second stationary portion 20. In this manner, the sealing arrangements 104, 105 form interfaces between the respective first and second stationary portions 12, 20 and the rotor casing 108. See also above concerning the mechanical hermetical properties of the sealing arrangements 104, 105 and the cooling of the sealing arrangements 104, 105.

FIG. 4 schematically illustrates a cross section through a portion of a modular centrifugal separator system 2. FIG. 4 inter alia shows a cross section through a housing 52, an entrainment member 32, and an exchangeable separation insert 6 of the modular centrifugal separator system 2. The modular centrifugal separator system 2 may be a modular centrifugal separator system 2 as discussed above in connection with FIGS. 1a and 1b. A base unit 4 of the separator system 2 may be base unit 4 as discussed above with reference to FIG. 2. The exchangeable separation insert 6 may be an exchangeable separation insert 6 as discussed above in connection with FIG. 3. Accordingly, in the following, reference is also made to FIGS. 1a-3.

In FIG. 4 the exchangeable separation insert 6 is shown mounted in the base unit 4. As mentioned above, the drive arrangement 32 comprises an entrainment member 34 which is journaled in the stationary frame 26.

A portion of the separation insert 6 comprising the first stationary portion 12 extends through the entrainment member 34. The entrainment member 34 engages with the rotor casing 8 of separation insert 6. The entrainment member 34 has an axial extension, e, <40%, such as <30%, such as <20% of a total axial extension of the rotor casing 8. The rotor casing 8 is supported in the entrainment member 34 over a distance, d, <10%, such as <5%, such as <3% of the total axial extension of the rotor casing 8.

The axial extension extends along the rotational axis 10 along the axial direction. The axial extension, e, of the entrainment member 34 is indicated with a curly bracket e in FIG. 4. The axial extension, e, of the entrainment member 34 extends in parallel with the rotational axis 10. The distance, d, over which the rotor casing 8 is supported in the entrainment member 34 is indicated with a curly bracket d in FIG. 4. The distance, d, over which the rotor casing 8 is supported in the entrainment member 34 extends in parallel with the rotational axis 10.

At least part of the first stationary portion 12 extends through the first opening 60. At least part of the second stationary portion 20 extends through the second opening 58 provided in the enclosing member 54 of the housing 52.

Accordingly, the base unit 4 comprises an enclosing member 54, which at least partially encloses the exchangeable separation insert 6. The rotor casing 8 of the exchangeable separation insert 6 may be brought into engagement with the entrainment member 34 by a force applied to the second stationary portion 20 along the axial direction by the enclosing member 54. In this manner, during use of the separator system 2, it may be ensured that when the drive arrangement 32 rotates the entrainment member 34, the rotor casing 8 is entrained to rotate with the engagement member 34.

In more detail, at least part of the second stationary portion 20 extends through the second opening 58 provided in the lid/enclosing member 54. The enclosing member 54 applies the force to the second stationary portion 20 by abutting thereagainst. The force is transferred from the second stationary portion 20 e.g., via the sealing arrangement 105 to the rotor casing 8. Thus, the rotor casing 8 of the exchangeable separation insert 6 is brought into engagement with the entrainment member 34. Such engagement may be purely frictional. Alternatively or additionally, the engagement may be provided by mating protrusions and recesses in the rotor casing 8 and the engagement member 34.

Also, in this manner, the second stationary portion 20 may be pressed against the rotor casing 8 such that one or both of the sealing arrangements 104, 105 provide/s its/their intended sealing function.

As mentioned above, in these embodiments, the entrainment member 34 comprises a frustoconical wall member 68. A conical or frustoconical portion of the separation insert 6 abuts against and is supported by the frustoconical wall member 68. Accordingly, in these embodiments, the supporting distance, d, which is provided by the entrainment member 34 is provided by the frustoconical wall member 68 of the entrainment member 34.

As mentioned above, the rotor casing 8 is supported in the entrainment member 34 over a distance, d, <10%, such as <5%, such as <3% of the total axial extension of the rotor casing 8. Mentioned purely as an example, the abutment length, L, between the frustoconical wall member 68 and the rotor casing 8 may be within a range of 5-30 mm. The distance, d, will depend on the angle between the axial direction and the frustoconical wall member 68.

In the illustrated embodiments, the frustoconical wall member 68 is provided as a separate wall section of the entrainment member 34. According to alternative embodiments, the frustoconical wall member 68 may be provided by an inner chamfered edge of an entrainment member 34. See further below with reference to FIG. 6a.

According to embodiments, a neck portion 120 of the second stationary portion 20 extends from a side of the enclosing member 54 facing the rotor casing 8 of the exchangeable separation insert 6 to a side of the enclosing member 54 facing an ambient environment of the modular centrifugal separator system 2. An engagement element 122 engages the neck portion 120 with the enclosing member 54. In this manner, the second stationary portion 20 may be fixed to the enclosing member 54 in order to provide the force causing the engagement between the rotor casing 8 and the entrainment member 34.

Also, in this manner the exchangeable separation insert 6 may be positioned in a correct axial position in the base unit 4.

Further, the second stationary portion 20 may be fixed by the engagement element 122 in relation to the stationary frame 26 during use of the separator system 2. Since the second stationary portion 20 is maintained in a predefined position during use of the separator system 2, also the fluid connection/s 24 provide at the second stationary portion is/are rotationally fixed during use of the separator system 2.

The engagement element 122 may engage with the neck portion 120 of the second stationary portion 20 e.g., via threads or a bayonet coupling.

As implied above in connection with FIG. 2, an engagement member 62 is arranged at an opposite axial end of the housing to the lid 54. The engagement member 62 is configured to engage with the first stationary portion 12 of the separation insert 6.

When engaged with the first stationary portion 12, the engagement member 62 and the first stationary portion 12 are fixed in relation to the stationary frame 26.

The engagement member 62 may for instance comprise inner threads and the first stationary portion 12 may comprise outer threads. Thus, the engagement member 62 may be threadedly engaged with the first stationary portion 12. According to alternative embodiments, a bayonet coupling may be provided between the engagement member 62 and the first stationary portion 12.

Since the first stationary portion 12 is fixed in relation to the stationary frame 26, also the fluid connection/s 16, 18 provide at the first stationary portion 12 is/are rotationally fixed during use of the separator system 2.

The engagement element 122 and the engagement member 62 may be separate parts, which are engaged with the respective second and first stationary portions 20, 12. The engagement element 122 and the engagement member 62 may be configured for multiple use since they do not come into contact with the liquids in the separator system 2.

FIGS. 5a and 5b schematically illustrate a modular centrifugal separator system 2 according to alternative embodiments. The separator system 2 resembles in much the separator system 2 discussed above with reference to FIGS. 1a-4. Accordingly, in the following mainly the differences will be discussed.

Again, the modular centrifugal separator system 2 comprises a base unit 4 and an exchangeable separation insert 6. In FIG. 5a, the modular centrifugal separator system 2 is shown in an assembled state i.e., with the separation insert 6 mounted in the base unit 4. In FIG. 5b, the exchangeable separation insert 6 is shown.

Again, the separation insert 6 is self-supporting and the rotor casing 8 may comprise a fibre reinforced portion 110 and a ring member 112.

In these embodiments, the separation insert 6 only comprise one stationary portion, the first stationary portion 12. Accordingly, all fluid connections 16, 18, 24 are provided in the first stationary portion 12.

The embodiments of FIGS. 1a-4 provide flexibility in that fluid connections may be arranged and distributed between upper and lower sides of the base unit i.e., at both axial ends of the rotor casing of the separation insert.

In the embodiments of FIGS. 5a and 5b, the possibility of having all fluid connections 16, 18, 24 at the lower end of the rotor casing 8 of the separation insert 6 is utilised. Thus, the flexibility provided by the separator system 2 with a self-supporting separation insert 6 extending through an entrainment member of the drive arrangement is utilised. Moreover, flexibility is provided in placement of the separator system 2 in a production facility. Since an upper side of the base unit 4 is kept free from fluid conduits, the base unit 4 may be positioned underneath other equipment without risk of the fluid connections disturbing access to such equipment arranged above the separator system 2.

Again, the housing 52 of the base unit 4 comprises an enclosing member 54 which is removable or repositionable to permit access to the inside of the housing 52 and the entrainment member of the drive arrangement of the separator system 2. Thus, the separation insert 6 may be mounted in and removed from the entrainment member.

The separation insert 6 comprises a support element 124 attached to an end of the rotor casing 8 opposite to the first stationary portion 12. The support element 124 is rotatably connected to the rotor casing 8 of the separation insert 6. Accordingly, the rotor casing 8 may rotate in relation to the support element 124. When the enclosing member 54 is positioned on the remainder of the housing 52, the enclosing member 54 abuts against the support element 124 and thus, supports the separation insert 6 at the end opposite to the first stationary portion 12. In this manner the rotor casing 8 of the exchangeable separation insert 6 may be brought into engagement with the entrainment member by a force applied to the support element 124 and the rotor casing 8 along the axial direction by the enclosing member 54.

Alternatively to providing the support element 124 on the separation insert 6, it may be provided on an inside of the enclosing member 54.

FIGS. 6a and 6b schematically illustrate entrainment members 34 according to alternative embodiments.

FIG. 6a shows a cross section through embodiments of a cylindrically shaped entrainment member 34 wherein an inner chamfered edge 126 provides a surface configured to abut against a conical or frustoconical outer surface of a rotor casing of a separation insert. Again, the chamfered edge 126 supports the rotor casing over a distance, d, <10%, such as <5%, such as <3% of the total axial extension of the rotor casing.

Again, the engagement between the separation insert and the engagement member 34 may be complemented with mating protrusions and recesses in the rotor casing and the engagement member 34.

FIG. 6b shows embodiments of a cylindrically shaped entrainment member 34. The entrainment member 34 has a support surface 128 extending perpendicularly to the axial direction. The support surface 128 provides a surface configured to abut against a corresponding outer surface portion of a rotor casing of a separation insert.

These embodiments provide an example wherein the distance along the axial extension over which the rotor casing is supported in the entrainment member 34 is substantially 0% of the total axial extension of the rotor casing. This so, since the support surface 128 extends perpendicularly to the axial direction.

Again, the engagement between the separation insert and the engagement member 34 may be complemented with mating protrusions and recesses in the rotor casing and the engagement member 34.

It is to be understood that the foregoing is illustrative of various example embodiments and that the invention is defined only by the appended claims. A person skilled in the art will realize that the example embodiments may be modified, and that different features of the example embodiments may be combined to create embodiments other than those described herein, without departing from the scope of the invention, as defined by the appended claims.

1. A modular centrifugal separator system configured for separating a liquid feed mixture into a heavy phase and a light phase, the modular centrifugal separator system comprising a base unit and an exchangeable separation insert,
wherein the base unit comprises a stationary frame and a drive arrangement for rotating at least a portion of the exchangeable separation insert about a rotational axis extending in an axial direction,
wherein the exchangeable separation insert comprises:
a rotor casing configured to rotate about the rotational axis and forming a separation space; and
a first stationary portion arranged at a first axial end portion of the rotor casing and comprising at least one fluid connection for one of the liquid feed mixture, the heavy phase, and the light phase,
wherein the drive arrangement comprises an entrainment member through which a portion of the exchangeable separation insert comprising the first stationary portion extends,
wherein the entrainment member is journalled in the stationary frame and engages with the rotor casing,
wherein the entrainment member has an axial extension <40% of a total axial extension of the rotor casing, and
wherein the rotor casing is supported in the entrainment member over a distance <10% of the total axial extension of the rotor casing.

2. The modular centrifugal separator system according to claim 1, wherein the rotor casing comprises a plastic material portion and a fibre reinforced portion extending circumferentially around the plastic material portion, the fibre reinforced portion being configured for rendering the rotor casing self-supporting during use of the modular centrifugal separator system.

3. The modular centrifugal separator system according to claim 2, wherein the rotor casing comprises a ring member extending along a periphery of the rotor casing, and
wherein the ring member supports an axially extending portion of the rotor casing and a radially extending portion of the rotor casing.

4. The modular centrifugal separator system according to claim 1, wherein the exchangeable separation insert comprises a second stationary portion arranged at a second axial end portion of the rotor casing, the second stationary portion comprising at least one fluid connection for one of the liquid feed mixture, the heavy phase, and the light phase.

5. The modular centrifugal separator system according to claim 4, wherein the base unit comprises an enclosing member, the enclosing member at least partially enclosing the exchangeable separation insert, and
wherein the rotor casing of the exchangeable separation insert is brought into engagement with the entrainment member by a force applied to the second stationary portion along the axial direction by the enclosing member.

6. The modular centrifugal separator system according to claim 5, wherein a neck portion of the second stationary portion extends from a side of the enclosing member facing the rotor casing of the exchangeable separation insert to a side of the enclosing member facing an ambient environment of the modular centrifugal separator system, and
wherein an engagement element engages the neck portion with the enclosing member.

7. The modular centrifugal separator system according to claim 1, wherein the exchangeable separation insert comprises a bearing forming a journal between the rotor casing and the second stationary portion of the exchangeable separation insert.

8. An exchangeable separation insert for a modular centrifugal separator system, the exchangeable separation insert comprising:
a rotor casing configured to rotate about a rotational axis extending in an axial direction, the rotor casing forming a separation space;
a first stationary portion arranged at a first axial end portion of the rotor casing; and
a second stationary portion arranged at a second axial end portion of the rotor casing,
wherein the first and second stationary portions comprise fluid connections for a liquid feed mixture, a separated heavy phase, and a separated light phase.

9. The exchangeable separation insert according to claim 8, wherein the rotor casing comprises a plastic material portion and a fibre reinforced portion extending circumferentially around the plastic material portion.

10. The exchangeable separation insert according to claim 9, wherein the rotor casing comprises a ring member extending along a periphery of the rotor casing, and
wherein the ring member supports an axially extending portion of the rotor casing and a radially extending portion of the rotor casing.

11. The exchangeable separation insert according to claim 8, further comprising a first sealing arrangement between the rotor casing and the first stationary portion and a second sealing arrangement between the rotor casing and the second stationary portion.

12. The modular centrifugal separator system according to claim 1, wherein the axial extension of the entrainment member is <30% of the total axial extension of the rotor casing.

13. The modular centrifugal separator system according to claim 1, wherein the axial extension of the entrainment member is <20% of a total axial extension of the rotor casing.

14. The modular centrifugal separator system according to claim 1, wherein the rotor casing is supported in the entrainment member over a distance <5% of the total axial extension of the rotor casing.

15. The modular centrifugal separator system according to claim 1, wherein the rotor casing is supported in the entrainment member over a distance <3% of the total axial extension of the rotor casing.

16. The modular centrifugal separator system according to claim 2, wherein the exchangeable separation insert comprises a second stationary portion arranged at a second axial end portion of the rotor casing, the second stationary portion comprising at least one fluid connection for one of the liquid feed mixture, the heavy phase, and the light phase.

17. The modular centrifugal separator system according to claim 3, wherein the exchangeable separation insert comprises a second stationary portion arranged at a second axial end portion of the rotor casing, the second stationary portion comprising at least one fluid connection for one of the liquid feed mixture, the heavy phase, and the light phase.

18. The modular centrifugal separator system according to claim 2, wherein the exchangeable separation insert comprises a bearing forming a journal between the rotor casing and the second stationary portion of the exchangeable separation insert.

19. The modular centrifugal separator system according to claim 3, wherein the exchangeable separation insert comprises a bearing forming a journal between the rotor casing and the second stationary portion of the exchangeable separation insert.

20. The modular centrifugal separator system according to claim 4, wherein the exchangeable separation insert comprises a bearing forming a journal between the rotor casing and the second stationary portion of the exchangeable separation insert.
